(19) United States
(12) Patent Application Publication
(10) Pub. No.: US 2026/0303847 A1
(43) Pub. Date: Oct. 1, 2026

(54) DECODER-SIDE INTRA MODE DERIVATION MERGE

(71) Applicant: Nokia Technologies Oy, Espoo (FI)

(72) Inventors: Saverio Blasi, London (GB); Ivan Zupancic, Munich (DE); Jani Lainema, Tampere (FI)

(21) Appl. No.: 19/491,014

(22) PCT Filed: May 29, 2024
(86) PCT No.: PCT/EP2024/064717

§ 371 Date: Dec. 8, 2025

Related U.S. Application Data
(60) Provisional application No. 63/511,779, filed on Jul. 3, 2023.

(51) Int. Cl. H04N 19/44; H04N 19/11; H04N 19/176

(52) U.S. Cl. CPC H04N 19/44; H04N 19/11; H04N 19/176

(57) ABSTRACT

In accordance with example embodiments of the invention there is at least a method and apparatus to perform forming an intra prediction block in accordance to a merged decoder side intra mode derivation process, where the merged decoder side intra mode derivation process includes: forming an intra prediction for a current block of video data by means of blending a number of predictors, where at least some of the predictors are obtained by determining intra prediction modes, where the intra prediction modes are determined based on a decoder side intra mode derivation process applied to at least one different block.

### TECHNICAL FIELD

The teachings in accordance with the exemplary embodiments of this invention relate generally to a new machine learning-dedicated bearer for machine learning or artificial intelligence related data exchange and, more specifically, relate to a new method and apparatus operating to at least produce an intra prediction for a given block using intra prediction.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:

| | |
|---|---|
| AMF | access and mobility function |
| CC | cross component |
| CCLM | cross-component linear model |
| CTU | coding tree unit |
| DIMD | decoder side intra mode derivation |
| ECM | exploration coding model |
| Intra TMP | intra template matching prediction |
| LMF | location management function |
| LUT | lookup table |
| MME | mobility management entity |
| MPM | most probable modes |
| NCE | network control element |
| PCF | policy control function |
| RAN | random access network |
| SGW | serving gateway |
| SMF | session management function |
| TM | template matching |
| UDM | unified data management |

### BRIEF DESCRIPTION OF PRIOR DEVELOPMENTS

Decoder side intra mode derivation (DIMD) for video codecs uses a method to determine the Intra mode of the current block using directionality of the texture of the neighboring reconstructed samples located in a template region at top, top-left, and left sides of the current block. In DIMD, one (or more) intra modes and their corresponding weight factors are derived first. Then, predictors are generated for these intra modes, and also for the Planar mode. A final intra prediction for the current block is generated by combining these predictors by means of sample-wise or uniform weighting, using the derived weights.

In an existing DIMD method, it is highly unlikely that two blocks with different neighbouring reference samples will produce identical DIMD histograms of gradients (e.g., amplitudes), and correspondingly identical directional modes and weights in the blending process. However, in some cases (e.g., different neighbouring blocks being part of the same object or texture) it may be beneficial to encode two or more neighbouring blocks using DIMD, with the same directional intra modes and weights. Furthermore, even if the same directional modes and weights are used for the neighbouring blocks, in the existing DIMD method they would be redundantly recalculated during the decoding process.

Example embodiments of this invention proposes at least improved operations for Decoder side intra mode derivation operations.

### SUMMARY

This section contains examples of possible implementations and is not meant to be limiting.

In another example aspect of the invention, there is an apparatus, such as a user equipment side apparatus, comprising: at least one processor; and at least one non-transitory memory storing instructions, that when executed by the at least one processor, cause the apparatus at least to: form an intra prediction block in accordance to a merged decoder side intra mode derivation process, wherein the merged decoder side intra mode derivation process includes: forming an intra prediction for a current block of video data by means of blending a number of predictors, wherein at least some of the predictors are obtained by determining intra prediction modes, and wherein the intra prediction modes are determined based on a decoder side intra mode derivation process applied to at least one different block.

In still another example aspect of the invention, there is a method, comprising: forming an intra prediction block in accordance to a merged decoder side intra mode derivation process, wherein the merged decoder side intra mode derivation process includes: forming an intra prediction for a current block of video data by means of blending a number of predictors, wherein at least some of the predictors are obtained by determining intra prediction modes, and wherein the intra prediction modes are determined based on a decoder side intra mode derivation process applied to at least one different block.

A further example embodiment is an apparatus and a method comprising the apparatus and the method of the previous paragraphs, wherein the at least one different block comprises at least one neighbouring block, wherein signalling is used to determine if the prediction for the current block should operate in accordance to a merged decoder side intra mode derivation process, wherein a presence of signalling is inferred based on at least one of whether any block of the at least one different block is coded using a decoder side intra mode derivation process, or whether any block of the at least one different blocks is coded using a merged decoder side intra mode derivation process, wherein the decoder side intra mode derivation process applied to at least one different block operates in dependence on the formation of a histogram of gradients, wherein the formation of the histogram of gradients includes spreading a given amplitude across multiple entries in the histogram of gradients, wherein based on an intra prediction mode number x being determined to have an amplitude A, the histogram of gradients is updated by adding A to the bin corresponding to mode x, and A/2 for the bins corresponding to the x−1 and x+1, wherein a histogram of gradients is computed for the current block based on the histogram of gradients extracted from a block of the at least one different block, wherein a histogram of gradients is computed for the current block based on the intra prediction modes used in the at least one different block, wherein the histogram of gradients computed for the current block is formed of a number of amplitudes for each intra prediction mode, wherein the amplitude for a given intra prediction mode is computed as the average of the amplitudes for that intra prediction mode extracted from the histogram of gradients of blocks of the at least one different block, wherein the average of the amplitudes is a weighted average, wherein the weights are computed depending on characteristics of the at least one different block, wherein the characteristics comprise at least one of a block size and width, or a block physical location in x and y coordinates within a frame, wherein the average of the amplitudes is a weighted average, wherein the weights are computed depending on characteristics of the current block, wherein the characteristics comprise at least one of a block size and width, or a block physical location in x and y coordinates within a frame, wherein a location dependency is computed for each intra prediction mode for the current block, wherein the location dependency is computed in dependency to the location dependency of intra prediction modes extracted from blocks of the at least one different block, wherein the merged decoder side intra mode derivation process includes determining one or more blocks to merge based on the size of the blocks to merge, wherein the merged decoder side intra mode derivation process includes determining one or more blocks to merge based on the location of the blocks to merge with respect to the current block, at least one of wherein the intra prediction modes and weights to use for the current block are set equal to the intra prediction modes and weights used in a block of the at least one different block coded in accordance to a decoder side intra mode derivation process, or wherein the intra prediction modes and weights to use for the current block are set equal to the intra prediction modes and weights used in a block of the at least one different block coded in accordance to a merged decoder side intra mode derivation process.

A non-transitory computer-readable medium storing program code, the program code executed by at least one processor to perform at least the method as described in the paragraphs above.

In yet another example aspect of the invention, there is an apparatus comprising: means for forming an intra prediction block in accordance to a merged decoder side intra mode derivation process, wherein the merged decoder side intra mode derivation process includes: means for forming an intra prediction for a current block of video data by means of blending a number of predictors, wherein at least some of the predictors are obtained by determining intra prediction modes, and wherein the intra prediction modes are determined based on a decoder side intra mode derivation process applied to at least one different block.

In accordance with the example embodiments as described in the paragraph above, at least the means for determining, using, obtaining, extracting or merging, and applying comprises a network interface, and computer program code stored on a computer-readable medium and executed by at least one processor.

A communication system comprising the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a block diagram of one possible and non-limiting exemplary system in which the example embodiments may be practiced; and

FIG. 2 shows a method in accordance with example embodiments of the invention which may be performed by an apparatus, such as an apparatus as shown in FIG. 1.

### DETAILED DESCRIPTION

In example embodiments of this invention there is proposed at least a method and apparatus operating to at least produce an intra prediction for a given block using intra prediction. This includes where the prediction for the current block is obtained by means of blending a number of predictors obtained with determined intra prediction modes using determined weights, and where the intra prediction modes and weights used to predict the current block are determined by using a Decoder side Intra Mode Derivation (DIMD) process applied to at least one different block.

As similarly stated above, decoder side intra mode derivation (DIMD) is a method to determine the Intra mode of the current block using directionality of the texture of the neighboring reconstructed samples located in a template region at top, top-left, and left sides of the current block. In DIMD, one (or more) intra modes are derived. In case more than one mode is derived, corresponding weight factors are also derived. Then, predictors are generated for these intra modes. Depending on certain conditions, a prediction can also be generated for the Planar mode. Then the final prediction for the current block is generated by combining the predictors by means of sample-wise or uniform weighting, using the derived weights.

In DIMD, directionality of texture is derived for each neighboring sample in the template region, using 3×3 neighboring samples of that sample. This derivation is performed in several steps. First, the horizontal and vertical direction strengths (Dx and Dy) are calculated using 3×3 neighbouring or different samples of the training sample. The corresponding region on the Intra prediction mode (angle) is determined using the sign of Dx and Dy. Then the ratio of Dx/Dy is calculated, and the corresponding angle index is determined using the ratio value and a table that maps the ratio to proper angle index. Then the final intra mode for that training sample is determined using the region and derived angle. The amplitude (or importance) of this intra mode is derived as the sum of absolute values of Dx and Dy.

The intra mode (corresponding to a given directionality) and its corresponding amplitude are derived as above for each training sample. These are then collected into a Histogram of Gradients, namely a histogram collecting for each intra mode the cumulative amplitude of all neighbouring samples with that directionality. Finally, one or more intra modes are derived from the histogram of gradients, by finding the dominant intra modes, namely the modes with the highest amplitudes in the histogram. The weights of each extracted intra mode are determined based on these amplitudes, where higher amplitudes correspond to higher weights. A fixed weight is typically assigned to the planar mode. In case there are more than one intra mode that can be determined from the Histogram of Gradients, the Planar mode is always blended together with the determined intra modes to form the final DIMD prediction.

It is noted that in accordance with example embodiments of the disclosure the term gradient(s) or amplitude(s) may be interchangeable, as their operations are associated.

Some extensions to the DIMD process considered in ECM also consider deriving for each intra mode derived during the DIMD process a location dependency, which determines whether a given intra mode should be blended spatially, giving higher weights in the above region or in the left region of the block. The location dependency is determined based on the Histogram of Gradients.

DIMD is considered in ECM as an option signalled at the encoder side. In addition, the DIMD modes (prior to blending) are also included in the list of Most Probable Modes (MPM) for signalling as individual MPM candidates.

Also as similarly stated above, in an existing DIMD method it is highly unlikely that two blocks will produce identical DIMD histograms of gradients, and correspondingly identical directional modes and weights in the blending process. This is because the formation of the Histogram of Gradients is highly influenced by local texture variations in the templates. However, in some cases (e.g., different blocks being part of the same object or texture) it may be beneficial to encode two or more blocks using the same directional intra modes and weights. Furthermore, even if the same directional modes and weights are used for the different blocks, in the existing DIMD method they would be redundantly recalculated during the decoding process. In addition, when more than one block encoded with DIMD are present in the neighbourhood, this may indicate that the current block may benefit from being encoded with intra modes that depend on the DIMD modes calculated in such neighbouring or different blocks.

When DIMD is applied, one (or more) intra modes are derived from the reconstructed neighbor samples, and those one (or more) predictors may be combined with the planar mode predictor with the weights derived from the amplitudes of the intra prediction directions as found in the Histogram of Gradients (e.g., amplitudes), as described in JVET-00449. The division operations in weight derivation can be performed utilizing the same lookup table (LUT) based integerization scheme used by the CCLM. For example, the division operation in the orientation calculation:

$$Orient = {G}_{y} / {G}_{x}$$

is computed by the following LUT-based scheme:

x = Floor( Log2( Gx ) )
normDiff = ( ( Gx<< 4 ) >> x ) & 15
x +=( 3 + ( normDiff != 0 ) ? 1 : 0 )
Orient = (Gy* ( DivSigTable[ normDiff ] | 8 ) + ( 1<<( x−1 ) )) >> x
where
DivSigTable[16] = { 0, 7, 6, 5 ,5, 4, 4, 3, 3, 2, 2, 1, 1, 1, 1, 0 }.

Derived intra modes are included into the primary list of intra most probable modes (MPM), so the DIMD process is performed before the MPM list is constructed.

In accordance with example embodiments of the invention there is a method and apparatus operating to at least produce an intra prediction for a given block using intra prediction, where the prediction for the current block is obtained by means of blending a number of predictors obtained with determined intra prediction modes using determined weights, where the intra prediction modes and weights used to predict the current block are determined by using a DIMD process applied to at least one different block.

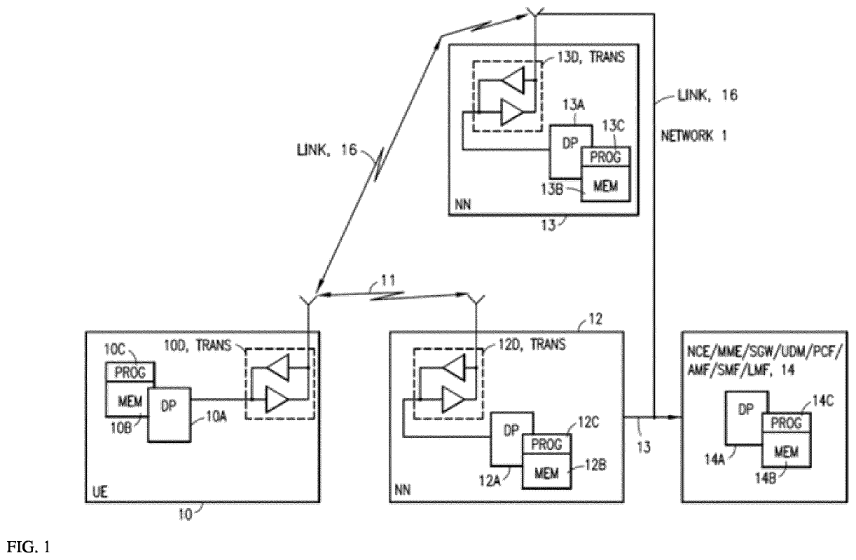

Before describing the example embodiments as disclosed herein in detail, reference is made to FIG. 1 for illustrating a simplified block diagram of various electronic devices that are suitable for use in practicing the example embodiments of this invention.

FIG. 1 shows a block diagram of one possible and non-limiting exemplary system in which the example embodiments may be practiced. In FIG. 1, a user equipment (UE) 10 is in wireless communication with a wireless network 1 or network, 1 as in FIG. 1. The wireless network 1 or network 1 as in FIG. 1 can comprise a communication network such as a mobile network e.g., the mobile network 1 or first mobile network as disclosed herein. Any reference herein to a wireless network 1 as in FIG. 1 can be seen as a reference to any wireless network as disclosed herein. Further, the wireless network 1 as in FIG. 1 can also comprise hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11 or 16.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 1. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 16. Further, the link 11, link 16 and/or any other link may be wired or wireless or both and may implement, e.g., an X2 or Xn interface. Further the link 11 and/or link 16 may be through other network devices such as, but not limited to an NCE/MME/SGW/UDM/PCF/AMF/SMF/LMF 14 device as in FIG. 1. The NN 12 may perform functionalities of an MME (Mobility Management Entity) or SGW (Serving Gateway), such as a User Plane Functionality, and/or an Access Management functionality for LTE and similar functionality for 5G.

The NN 13 can be for WiFi or Bluetooth or other wireless device associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 16 or another link. The Link 16 as shown in FIG. 1 can be used for communication with the NN 12. These links maybe wired or wireless or both and may implement, e.g., an X2 or Xn interface. Further, as stated above the link 11 and/or link 16 may be through other network devices such as, but not limited to an NCE/MME/SGW device such as the NCE/MME/SGW/UDM/PCF/AMF/SMF/LMF 14 of FIG. 1.

The one or more buses of the device of FIG. 1 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 1 shows network nodes such as NN 12 and NN 13, any of these nodes can incorporate or be incorporated into an eNodeB or eNB or gNB such as for LTE and NR and would still be configurable to perform example embodiments.

Also, it is noted that description herein indicates that “cells” perform functions, but it should be clear that the gNB that forms the cell and/or a user equipment and/or mobility management function device will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments in any of an LTE, NR, 5G and/or any standards based communication technologies being performed or discussed at the time of this application. In addition, it is noted that the operations in accordance with example embodiments, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or link 16. In accordance with the example embodiments these network interfaces can include X2 and/or Xn interfaces for use to perform the example embodiments. The one or more memories MEM 14B include computer program code PROG 14C. The one or more memories MEM 14B and the computer program code PROG 14C are configured to, with the one or more processors DP 14A, cause the NCE/MMF/SGW/UDM/PCF/AMF/SMF/LMF 14 to perform one or more operations which may be needed to support the operations in accordance with the example embodiments.

It is noted that that the NN 12 and/or NN 13 and/or UE 10 can be configured (e.g., based on standards implementations etc.) to perform functionality of a Location Management Function (LMF). The LMF functionality may be embodied in any of these network devices or other devices associated with these devices. In addition, an LMF such as the LMF of the MMF/SGW/UDM/PCF/AMF/SMF/LMF 14 of FIG. 1, as at least described below, can be co-located with UE 10 such as to be separate from the NN 12 and/or NN 13 of FIG. 1 for performing operations in accordance with example embodiments as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

In general, various embodiments of any of these devices can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of any of these devices can be used with a UE vehicle, a High Altitude Platform Station, or any other such type node associated with a terrestrial network or any drone type radio or a radio in aircraft or other airborne vehicle or a vessel that travels on water such as a boat.

As similarly stated above, in accordance with example embodiments of the invention there is at least producing an intra prediction for a given block using intra prediction, where the prediction for the current block is obtained by means of blending a number of predictors obtained with determined intra prediction modes using determined weights, where the intra prediction modes and weights used to predict the current block are determined by using a DIMD process applied to at least one different block.

A method operating according to the invention produces an intra prediction for a given block using intra prediction, where a number of intra prediction modes and weights are used to predict the content of the current block, where the intra prediction modes and weights used to predict the current block are obtained as a result of combining the DIMD information extracted from a number of neighbouring or different blocks.

A method operating according to the invention produces an intra prediction for a given block using intra prediction, where the intra prediction process applied to the current block operates in dependence on the Histogram of Gradients computed during the DIMD process on at least one neighbouring or different block.

A method operating according to the invention produces an intra prediction for a given block using intra prediction, where the prediction for the current block is obtained by means of blending a number of predictors obtained with determined intra prediction modes using determined weights, where the intra prediction modes and weights used to predict the current block are determined by using a DIMD process applied to at least one different block. As an example, two neighbouring or different blocks are considered, namely a block located above the current block, and a block located on the left of the current block. As an example, a number of neighbouring or different blocks are considered, including a block located on the top-left of the current block, one or more blocks located on the top of the current block, a block located on the top-right of the current block, one or more blocks located on the left of the current block, a block located on the bottom-left of the current block. As an example, the neighbouring or different blocks which are considered are the ones which contain the following pixel positions (relative to the top-left pixel of the current block position): (0, −1), (W−1, −1), (W, −1), (−1, −1), (−1, 0), (−1, H−1), (−1, H). As an example, only neighbouring or different blocks that are encoded using the DIMD mode are considered as valid neighbours. As an example, a block is considered to be coded with the DIMD mode also if it is coded using the DIMD merge mode. As an example, up to nine neighbouring or different blocks are considered, including the blocks that contain the following pixel positions: (W/2, −1), (−1, H/2). As an example, up to thirteen neighbouring or different blocks are considered, including the blocks that contain the following pixel positions: (W/4, −1), (3 W/4, −1), (−1, H/4), (−1, 3H/4). As another example, the neighbourhood of the current block may be searched to extract all blocks that are encoded using DIMD. As another example, neighbouring or different blocks encoded using merged DIMD may be also extracted.

The method operating according to the invention produces an intra prediction for a given block in accordance to a DIMD process applied to at least one different block. As an example, these blocks may not be directly adjacent to the current block. As an example, these blocks may be extracted from a pre-defined area in the surrounding of the current block. As an example, these blocks may be extracted at specific locations at a given distance from the current block.

The DIMD information from neighbouring or different blocks is extracted and merged (or inherited) for usage in the current block. As an example, in case exactly one neighbouring or different block is encoded with DIMD mode, its DIMD intra modes and weights can be directly merged to be used in the current block. As an example, in case more than one neighbouring or different blocks are encoded with DIMD mode, then the neighbouring or different block with larger size can be merged. As an example, in case more than one neighbouring or different blocks are encoded with DIMD mode, then a determined block can be considered, depending on its position with respect to the current block. As an example, in case any of the neighbouring or different blocks are coded using merged DIMD, which may be also referred to as DIMD merge, then they can be considered as DIMD coded. For clarity, a block is considered to be encoded with merged DIMD (or DIMD merge) if it is encoded according to the method operating according to the invention. As an example, if a neighbouring or different block was coded using DIMD merge, resulting in a number of intra prediction modes and weights determined to predict that neighbouring or different block, those intra prediction modes and weights may be merged for usage in the current block.

As an additional example, the shape of the candidate blocks can be considered if there are more than one neighbouring or different DIMD coded blocks and only one is selected as the source block for merging the DIMD information. For example, the horizontal distances of the left borders of the candidate blocks on the left side of the current block and vertical distances of the top borders of the candidate blocks above the current block can be determined with respect to the borders for the current block, and the candidate with smallest distance can be selected as the source for merging information. For example, if there is a candidate block of size 8×8 samples on the left side of the current block with its further away border having a distance of 8 samples from the border of the current block, and there is a candidate block of size 16×4 samples above the current block with its further away border having a distance of 4 samples from the border of the current block, the latter one can be selected due to its template region being closer to the current block.

As an additional example, the distance of the candidate blocks can be considered if there are more than one neighbouring or different DIMD coded blocks and only one is selected as the source block for merging the DIMD information. For example, the sum of absolute horizontal and vertical block distances between the current and the neighbouring or different blocks can be determined, D=abs(x_{c}−xₙ)+abs(y_{c}−yₙ), where (x_{c}, y_{c}) is the position of the top-left corner of the current block and (xₙ, yₙ) is the position of the top-left corner of the neighbouring or different block, and the candidate with the smallest distance D can be selected as the source for merging information.

As an additional example, the Euclidean distance of the candidate blocks can be considered if there are more than one neighbouring or different DIMD coded blocks and only one is selected as the source block for merging the DIMD information. For example, the Euclidean distance between the current and the neighbouring or different blocks can be determined, E=sqrt((x_{c}−xₙ)\hat{ }2+(y_{c}−yₙ)\hat{ }2), where (x_{c}, y_{c}) is the position of the top-left corner of the current block and (xₙ, yₙ) is the position of the top-left corner of the neighbouring or different block, and the candidate with the smallest Euclidean distance E can be selected as the source for merging information.

As an example, the usage of this method can be signalled at the block level under the following conditions: an additional DIMD merge flag is signalled directly after the DIMD flag only if the current block is encoded using the DIMD mode and if at least one of the neighbouring or different blocks is encoded with DIMD mode. As an example, an additional DIMD merge flag is signalled directly after the DIMD flag only if the current block is encoded using the DIMD mode and if at least one of the neighbouring or different blocks is encoded with DIMD mode. As an example, usage of this method can be inferred.

Another method operating according to the invention produces an intra prediction for a given block using intra prediction, where a number of intra prediction modes and weights are used to predict the content of the current block, where the intra prediction modes and weights are derived by means of computing parameters which may include a histogram of gradients, where the computed parameters for the current block are obtained by merging or combining the DIMD parameters extracted from a number of neighbouring or different blocks. As an example, in case only one neighbouring or different block was encoded with the DIMD mode, then its DIMD parameters can be merged, meaning they can be directly copied, for usage in the current block. As an example, in case only one neighbouring or different block was encoded with the DIMD mode, then its histogram of gradients can be merged to the current block. As an example, in case only one neighbouring or different block was encoded with the DIMD mode, then the DIMD intra prediction modes and their corresponding amplitudes in the histogram of gradients of the neighbouring or different block can be merged to the current block.

As an example, if more than one neighbouring or different blocks were encoded with the DIMD mode, their corresponding histograms of gradients can be combined to produce a single, new histogram of gradients for the current block. When combining the histograms from the neighbouring DIMD blocks, different approaches may be used. As an example, the histograms of the neighbouring or different blocks can be combined into a single histogram by means of a weighted average.

The weights to combine the neighbouring or different DIMD histograms in order to produce a new histogram of gradients for the current block can be uniform or can be determined based on some block-specific features, such as the block size, the prediction mode, or the number of samples used to compute the histogram of gradients for the neighbouring block. As an example, the weights can depend on characteristics of the neighbouring blocks from which the histograms are extracted. As an example, the histogram of a given neighbouring or different block can be multiplied by a factor in dependence to the size of that neighbouring block, and the scaled histograms from all neighbouring blocks can be summed together, and then the resulting amplitudes can be normalized by the sum of all factors. As another example, the weighting factors may depend on the location of the neighbouring block with respect to the current block.

The weights of the neighbouring DIMD histograms can be derived from the size of the neighbouring or different DIMD block. As an example, the weight for the histogram extracted from a neighbouring or different block with size W*H can be calculated as log 2(W*H), or equivalently as log 2(W)+log 2(H), where W and H are the width and the height of the neighbouring or different block, respectively. Other weighting mechanisms may be employed. As an example, different weights can be used if merging a block that was coded using conventional DIMD or DIMD merge. As an example, the amplitudes of modes extracted from DIMD merge blocks can be multiplied by a factor. As an example, a factor equal to 0.9 may be used. As an example, this factor would ensure that if we continue merging the same DIMD information from one block to another, the corresponding amplitudes would become smaller in each merging operation, which means that histograms computed on regular DIMD blocks would have a higher impact.

The formation of the histogram of gradients for the current block may also depend on the computation of decoder side intra mode derivation parameters directly on the current block. The derived histogram of gradients can be combined with the merged histogram of gradients extracted from a block of at least one different block such as neighbouring blocks. As another example, the derived histogram of gradients for the current block can be used to determine a number of intra prediction modes, and these intra prediction modes can be used during the formation of the merged histogram of gradients. As another example, the derived histogram of gradients and the merged histogram of gradients can be used in combination to derive the intra prediction modes and weights to predict the current block.

As an additional example, if more than one neighbouring or different block were encoded with the DIMD mode and or with the merged DIMD mode, a combined histogram of gradients can be determined using the intra prediction modes and weights of those neighbors. As such intra prediction modes represent typically only a subset of intra prediction modes in a full histogram of gradients, the impact of the intra prediction modes can be spread across multiple entries in the histogram. For example, if intra prediction mode number x is present in a neighboring or different block with an amplitude of A, the impact of this mode in the new histogram of gradients can be considered as A for mode x and A/2 for modes x−1 and x+1. Naturally other selections can be also made with spreading more of the weight to the adjacent intra prediction modes or modes that are further away from the mode x.

As an additional example, if more than one neighbouring blocks were encoded with the DIMD mode and or with the merged DIMD mode, a subset of these blocks can be considered for computing the intra prediction for the current block. As an example, a fixed maximum number of blocks may be considered, such that if there are more than this fixed maximum number of neighbouring DIMD blocks, then some of these neighbouring blocks are not considered when computing the intra prediction for the current block. As an example, the neighbouring blocks to consider for computing the intra prediction for the current block may be determined based on the block's size. As an example, the neighbouring blocks to consider for computing the intra prediction for the current block may be determined based on the neighbouring block's positions with respect to the current block. As an example, the neighbouring blocks to consider for computing the intra prediction for the current block may be determined based on a fixed order. As an example, no more than three neighbouring blocks are considered to compute the intra prediction for the current block.

Once the new histogram is generated, a number of intra prediction modes and weights can be derived, as an example a given number of modes corresponding to the modes with the highest amplitudes in the histogram may be considered. As an example, instead of combining the DIMD histograms of the neighbouring or different blocks, the DIMD intra prediction modes and weights of the neighbouring or different blocks can be combined to derive a new set of intra prediction modes and weights to use on the current block. As an example, instead of combining the DIMD histograms of the neighbouring or different blocks, the DIMD intra prediction modes and their corresponding amplitudes in the histogram of gradients of the neighbouring or different blocks can be combined to derive a new set of intra prediction modes and weights to use on the current block. As an example, a given number of modes corresponding to the modes with the highest amplitudes among all modes extracted from neighbouring or different blocks may be considered. As an example, the intra prediction modes and weights can be directly inherited by the current block from a specific neighbouring or different DIMD block. As an example, signalling can be employed to determine which neighbouring or different blocks to use to extract the DIMD information for usage in the current block. As an example, if more than one neighbouring or different block is encoded with DIMD, then additional signalling can be employed to determine which neighbouring or different block to consider, and the corresponding DIMD modes and weights are merged on the current block.

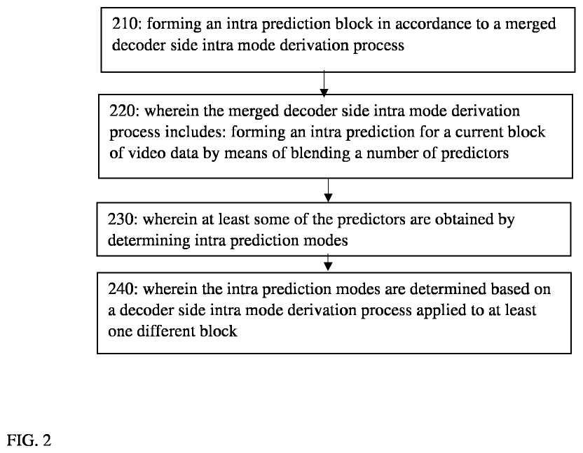

FIG. 2 illustrates operations which may be performed by a device such as, but not limited to, a device such as network node (e.g., the UE 10 as in FIG. 1). As shown in block 210 of FIG. 2 there is forming an intra prediction block in accordance to a merged decoder side intra mode derivation process. As shown in step 220 of FIG. 2 wherein the merged decoder side intra mode derivation process includes: forming an intra prediction for a current block of video data by means of blending a number of predictors. As shown in block 230 of FIG. 2 where at least some of the predictors are obtained by determining intra prediction modes. Then as shown in block 240 of FIG. 2 wherein the intra prediction modes are determined based on a decoder side intra mode derivation process applied to at least one different block.

In accordance with the example embodiments as described in the paragraphs above, wherein the at least one different block comprises at least one neighbouring block.

In accordance with the example embodiments as described in the paragraphs above, wherein signalling is used to determine if the prediction for the current block should operate in accordance to a merged decoder side intra mode derivation process.

In accordance with the example embodiments as described in the paragraphs above, wherein a presence of signalling is inferred based on at least one of whether any block of the at least one different block is coded using a decoder side intra mode derivation process, or whether any block of the at least one different block is coded using a merged decoder side intra mode derivation process.

In accordance with the example embodiments as described in the paragraphs above, wherein the decoder side intra mode derivation process applied to the at least one block operates in dependence on the formation of a histogram of gradients.

In accordance with the example embodiments as described in the paragraphs above, wherein the formation of the histogram of gradients includes spreading a given amplitude across multiple entries in the histogram of gradients.

In accordance with the example embodiments as described in the paragraphs above, wherein based on an intra prediction mode number x being determined to have an amplitude A, the histogram of gradients is updated by adding A to the bin corresponding to mode x, and A/2 for the bins corresponding to the x−1 and x+1.

In accordance with the example embodiments as described in the paragraphs above wherein a histogram of gradients is computed for the current block based on the histogram of gradients extracted from a block of the at least one different block.

In accordance with the example embodiments as described in the paragraphs above, wherein a histogram of gradients is computed for the current block based on the intra prediction modes used in blocks of the at least one different block.

In accordance with the example embodiments as described in the paragraphs above, wherein the histogram of gradients computed for the current block is formed of a number of amplitudes for each intra prediction mode, and wherein the amplitude for a given intra prediction mode is computed as the average of the amplitudes for that intra prediction mode extracted from the histogram of gradients of blocks of the at least one different block.

In accordance with the example embodiments as described in the paragraphs above, wherein the average of the amplitudes is a weighted average, wherein the weights are computed depending on characteristics of the at least one different block, and wherein the characteristics comprise at least one of a block size and width, or a block physical location in x and y coordinates within a frame.

In accordance with the example embodiments as described in the paragraphs above, wherein the average of the amplitudes is a weighted average, wherein the weights are computed depending on characteristics of the current block, and wherein the characteristics comprise at least one of a block size and width, or a block physical location in x and y coordinates within a frame.

In accordance with the example embodiments as described in the paragraphs above, wherein a location dependency is computed for each intra prediction mode for the current block, and wherein the location dependency is computed in dependency to the location dependency of intra prediction modes extracted from blocks of the at least one different block.

In accordance with the example embodiments as described in the paragraphs above, wherein the merged decoder side intra mode derivation process includes determining one or more blocks of the at least one different block to merge based on the size of the blocks to merge.

In accordance with the example embodiments as described in the paragraphs above, wherein the merged decoder side intra mode derivation process includes determining one or more blocks to merge based on the location of the blocks to merge with respect to the current block.

In accordance with the example embodiments as described in the paragraphs above, wherein the intra prediction modes and weights to use for the current block are set equal to the intra prediction modes and weights used in a block of the at least one different block coded in accordance to a decoder side intra mode derivation process.

In accordance with the example embodiments as described in the paragraphs above, wherein the intra prediction modes and weights to use for the current block are set equal to the intra prediction modes and weights used in a block of the at least one different block coded in accordance to a merged decoder side intra mode derivation process.

A non-transitory computer-readable medium (MEM 10B as in FIG. 1) storing program code (PROG 10C as in FIG. 1), the program code executed by at least one processor (DP 10A as in FIG. 1) to perform the operations as at least described in the paragraphs above.

In accordance with an example embodiment of the invention as described above there is an apparatus comprising: means for forming (TRANS 10D; DP 10A, PROG 10C, and MEM 10B as in FIG. 1) an intra prediction block in accordance to a merged decoder side intra mode derivation process, where the merged decoder side intra mode derivation process includes: means for forming (TRANS 10D; DP 10A, PROG 10C, and MEM 10B as in FIG. 1) an intra prediction for a current block of video data by means of blending a number of predictors, where at least some of the predictors are obtained (TRANS 10D; DP 10A, PROG 10C, and MEM 10B as in FIG. 1) by determining (TRANS 10D; DP 10A, PROG 10C, and MEM 10B as in FIG. 1) intra prediction modes, and where the intra prediction modes are determined based on a decoder side intra mode derivation process applied (TRANS 10D; DP 10A, PROG 10C, and MEM 10B as in FIG. 1) to at least one different block.

In the example aspect of the invention according to the paragraph above, wherein at least the means for forming, obtaining, determining, using, obtaining, and applying comprises a non-transitory computer readable medium [MEM 10B as in FIG. 1] encoded with a computer program [PROG 10C as in FIG. 1] executable by at least one processor [DP 10A as in FIG. 1].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass a presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-34. (canceled)

35. An apparatus, comprising:
at least one processor, and
at least one memory storing instructions, that when executed by the at least one processor, cause the apparatus at least to:
form an intra prediction block based on a merged decoder side intra mode derivation process, wherein the merged decoder side intra mode derivation process comprises:
forming an intra prediction for a current block of video data by blending a number of predictors, wherein at least some of the predictors are obtained by determining intra prediction modes, wherein the intra prediction modes are determined based on a decoder side intra mode derivation process applied to at least one different block.

36. The apparatus of claim 35, wherein the at least one different block comprises at least one neighbouring block.

37. The apparatus of claim 35, wherein signalling is used to determine whether the intra prediction for the current block should operate based on the merged decoder side intra mode derivation process.

38. The apparatus according to claim 35, wherein a presence of signalling is inferred based on at least one of whether any block of the at least one different block is coded using the decoder side intra mode derivation process, or whether the any block of the at least one different block is coded using the merged decoder side intra mode derivation process.

39. The apparatus of claim 35, wherein the decoder side intra mode derivation process applied to the at least one different block operates based on the formation of a histogram of gradients.

40. The apparatus according to claim 39, wherein the formation of the histogram of gradients comprises spreading a given amplitude across multiple entries in the histogram of gradients.

41. The apparatus according to claim 39, wherein the apparatus is further caused to:
determine number x to comprises an amplitude A based on an intra prediction mode; and
update the histogram of gradients by adding A to bin corresponding to mode x, and A/2 to bins corresponding to modes x−1 and x+1.

42. The apparatus according to claim 35, wherein the apparatus is further caused to: compute a histogram of gradients for the current block based on one of following:
the histogram of gradients extracted from a block of the at least one different block; or
the intra prediction modes used in the at least one different block.

43. The apparatus according to claim 42, wherein the histogram of gradients computed for the current block comprises a number of amplitudes for each intra prediction mode, wherein an amplitude for a given intra prediction mode is computed as an average of amplitudes for the given intra prediction mode extracted from the histogram of gradients of blocks of the at least one different block.

44. The apparatus of claim 43, wherein the average of amplitudes is a weighted average, and wherein weights are computed based on characteristics of the at least one different block, wherein the characteristics comprise at least one of a block size and width, or a block physical location in x and y coordinates within a frame.

45. The apparatus of claim 43, wherein the average of amplitudes is a weighted average, and wherein weights are computed based on characteristics of the current block, and wherein the characteristics comprise at least one of the block size and width, or the block physical location in x and y coordinates within a frame.

46. The apparatus of claim 35, wherein the apparatus is further caused to perform: computing a location dependency for each intra prediction mode for the current block, wherein the location dependency is computed based on a location dependency of intra prediction modes extracted from a block of the at least one different block.

47. The apparatus of claim 35, wherein the merged decoder side intra mode derivation process comprises determining one or more blocks to merge based on one of the following:
a size of the blocks of the at least one different block; or
a location of the at least one different block with respect to the current block.

48. The apparatus of claim 35, wherein the intra prediction modes and weights to
use for the current block are set equal to the intra prediction modes and weights used in a block of the at least one different block are coded based on one of the following:
a decoder side intra mode derivation process; or
the merged decoder side intra mode derivation process.

49. A method, comprising:
forming an intra prediction block based on a merged decoder side intra mode derivation process, wherein the merged decoder side intra mode derivation process comprises:
forming an intra prediction for a current block of video data by blending a number of predictors, wherein at least some of the predictors are obtained by determining intra prediction modes, wherein the intra prediction modes are determined based on a decoder side intra mode derivation process applied to at least one different block.

50. The method of claim 49, wherein the at least one different block comprises at least one neighbouring block.

51. The method of claim 49, wherein signalling is used to determine whether the intra prediction for the current block should operate based on the merged decoder side intra mode derivation process.

52. The method of claim 49, wherein a presence of signalling is inferred at least one of based on at least one of whether any block of the at least one different block is coded using a decoder side intra mode derivation process, or based on whether the any block of the at least one different block is coded using the merged decoder side intra mode derivation process.

53. The method of claim 49, wherein the decoder side intra mode derivation process applied to the at least one different block operates based on the formation of a histogram of gradients.

54. The method according to claim 49, wherein the formation of the histogram of gradients comprises spreading a given amplitude across multiple entries in the histogram of gradients.
